(19) United States
(12) Patent Application Publication
(10) Pub. No.: US 2009/0160896 A1
(43) Pub. Date: Jun. 25, 2009

(54) INK-JET TYPE IMAGE-FORMING APPARATUS

(75) Inventors: Takashi YAMAGATA, Nagareyama-shi (JP); Hiroyuki ISHINAGA, Tokyo (JP)

Correspondence Address: PATENTTM.US, P. O. BOX 82788, PORTLAND, OR, 97282-0788, US

(73) Assignee: CANON FINETECH INC., Ibaraki (JP)

(21) Appl. No.: 12/336,453

(22) Filed: Dec. 16, 2008

(30) Foreign Application Priority Data
Dec. 21, 2007 (JP) 2007-329539

(51) Int. Cl. B41J 29/38

(52) U.S. Cl. 347/14; 347/17

(57) ABSTRACT

An ink-jet type image-forming apparatus is provided which is improved in ink ejection performance and ink ejection reliability by retarding increase of the ink viscosity. In this apparatus, the ink in nozzles is not heated immediately before the printing (no voltage pulse is applied to the heater 152) to retard the viscosity increase by evaporation of water from the ink; the interval between the succeeding ejections from the respective nozzle is estimated from the printing data; and plural voltage pulses P1 are applied to the heater 152 to a temperature so as not to cause ink ejection. Thereby the increase of the viscosity is retarded to improve the ink ejection performance and the ink ejection reliability

### TECHNICAL FIELD

The present invention relates to an ink-jet type image-forming apparatus for forming an image by ejecting an ink from a nozzle of a recording head onto a recording medium.

### RELATED BACKGROUND ART

In ink ejection by an ink-jet type image-forming apparatus (ink-jet recorder), ink ejection performance and ink ejection reliability depend on the properties of the ink, especially on the viscosity of the ink. The ink ejection performance is higher with an ink of a lower viscosity, whereas the ink ejection performance is lower with an ink of a higher viscosity. The ink ejection failure occurs more frequently with an ink having a viscosity higher than about 5 mPa·s. To prevent the ink ejection failure in an ink-jet recording, a technique is known in which the ink in all the nozzles of the recorder is kept heated uniformly at a temperature so as not to cause ink ejection even during the time in which image formation is not conducted (see for example, Japanese Patent Application Laid-Open No. 2004-017457).

In image formation on a recording medium, ink is ejected from selected nozzles, so that not all nozzles are employed for the formation of a certain kind of image. In the nozzle which has not been employed for ink ejection for a long time, the ink in the nozzle which has not been employed becomes viscous gradually (increases the ink viscosity) owing to by evaporation of water (drying) to cause failure of the ink ejection. In the above-mentioned technique, all of the nozzles are heated uniformly, resulting in promotion of water evaporation from the ink to increase the viscosity of the ink disadvantageously.

### DISCLOSURE OF THE INVENTION

The inkjet type image-forming apparatus of the present invention which forms an image on a recording medium by ejection of an ink from a plurality of nozzles selectively, comprises:
(1) a calculation unit for calculating a time of standby of the nozzle to be employed for image formation,
(2) a judgment unit for judging relation of the viscosity of the ink with the time of non-ejection, and
(3) a selection unit for selecting the ink of the nozzle to be heated based on the judgment by the judgment unit; and
(4) ejecting the ink from the nozzles after completion of the control by the selection unit to form an image.

Further, the ink-jet type image-forming apparatus of the present invention has a recording head having a plurality of nozzles for ejecting an ink by heating by a heater element provided in each of the nozzles, and a controller for controlling the heater elements based on received printing data; and forming an image by ejection of the ink from a nozzle selected from the plurality of the nozzles onto a recording medium, wherein
(5) the controller does not energize the heater elements before receiving the printing data, and energizes selectively the heater elements on receiving the printing data to a temperature so as not to cause ejection of the ink in accordance with exposure time between completion of the previous ejection based on the previously received printing data and start of the subsequent ink ejection based on the subsequently received printing data, and further energizes the selected heater elements to eject the ink from the plural nozzles based on the subsequently received printing data.
(6) The ink may be heated intermittently.
(7) The controller may apply a voltage pulse to the heater element in controlling the heater element to a temperature so as not to cause ejection of the ink.
(8) The controller may change the number of the voltage pulses applied to the heater element in accordance with the respective exposure time of the nozzles.
(9) The controller may change the width of the pulse applied to the heater element in accordance with the respective exposure time of the nozzles.
(10) The controller may change the intensity of the pulse applied to the heater element is changed in accordance with the respective exposure time of the nozzles.

### BRIEF DESCRIPTION OF THE DRAWINGS

FIG. 1 is a perspective view illustrating an external appearance of an ink-jet type image-forming apparatus of the present invention.

FIG. 2 is a front view illustrating schematically the internal structure of the ink-jet recording apparatus illustrated in FIG. 1.

FIG. 3 is a perspective view illustrating an arrangement of four recording heads.

FIG. 4 is a sectional view of a nozzle and periphery thereof.

FIG. 5 is a block diagram illustrating the electric system of the ink-jet recording apparatus illustrated in FIG. 1.

FIG. 6A is a graph showing voltage pulses in a conventional method. FIG. 6B is a graph of an example of voltage pulses in the present invention.

FIG. 7 is a graph showing dependence of the viscosity of the ink on the temperature, the abscissa indicating the temperature (° C.), and the ordinate indicating the viscosity (mPa·s) of the ink.

FIG. 8 is a graph showing the change of the ink viscosity on the positions in the nozzle, the abscissa indicating the time (seconds), and the ordinate indicating the viscosity (mPa·s) of the ink.

FIG. 9 is a graph showing the change of the ink viscosity at the midpoint between the heating element and ink ejection outlet, the abscissa indicating the time (seconds), and the ordinate indicating the viscosity (mPa·s) of the ink.

FIG. 10 is schematic drawings illustrating change of the ink viscosity.

FIG. 11 is a schematic drawing showing difference in ink viscosity between the front portion and the rear portion in the nozzle.

FIG. 12 illustrates schematically an example of the present invention.

FIG. 13 is a graph showing an example of change of the ink viscosity with time in the present invention.

FIG. 14 illustrates schematically another example of the present invention.

FIG. 15 is a table showing the time tw and the time th depending on the time tx.

### DESCRIPTION OF THE PREFERRED EMBODIMENTS

The present invention is accomplished to apply to an ink-jet type image-forming apparatus in which a plurality of long recording heads are arranged in the direction of a recording medium delivery.

### EXAMPLE 1

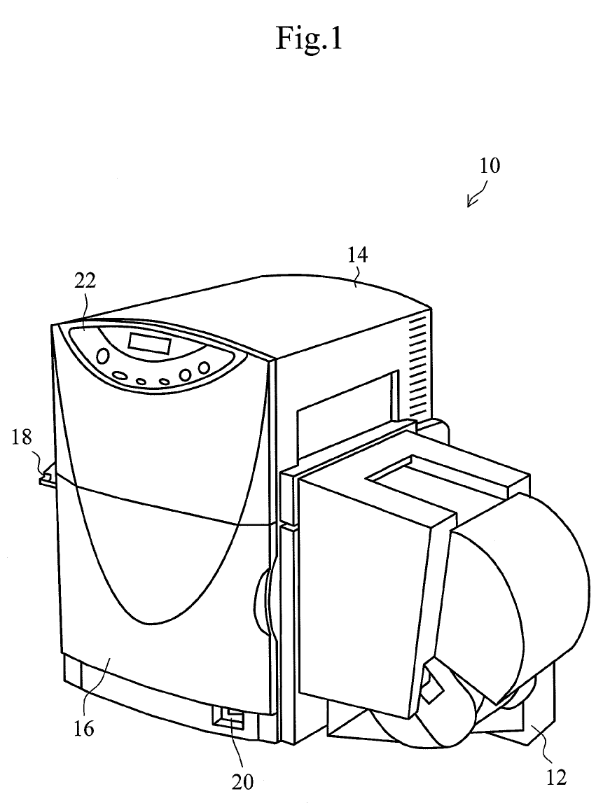

An example of the ink-jet image-forming apparatus of the present invention is described with reference to FIG. 1.

FIG. 1 is a perspective view illustrating an external appearance of an ink-jet type image-forming apparatus of the present invention.

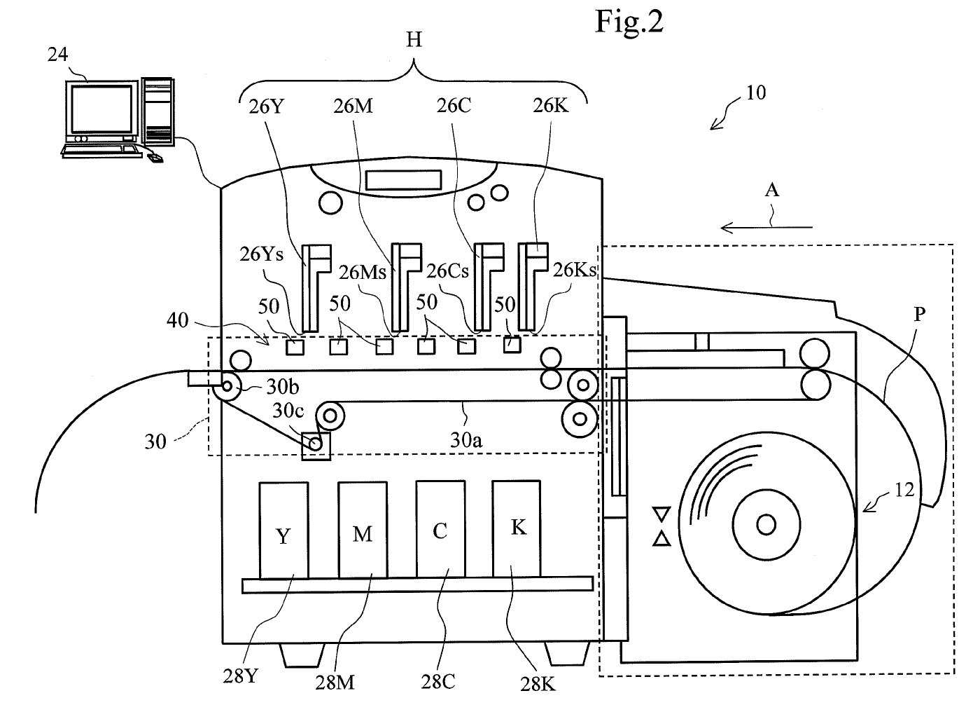

The ink-jet recording apparatus 10 conducts recording with a full-line heads having respectively a length corresponding to the sheet width of a rolled recording sheet P (FIG. 2). The rolled recording sheet P is housed in a roll unit 12. An openable top cover 14 is provided on the top of the main body. Under the top cover 14, built-in recording heads H (FIG. 2) and a delivery assembly for delivering the recording sheet P are equipped. An openable front cover is provided on the front side of the main body. Inside the front cover 16, main tanks 28K, 28C, 28M, 28Y (FIG. 2) are placed for storing the liquid inks to be fed to the recording heads H. The top cover 14 and the front cover 16 constitute the outer wall of the casing. On the lateral side of the main body, a cutter 18 is equipped for cutting the rolled recording sheet after recording. A power switch 20 of the ink-jet recording apparatus 10 is equipped below the front cover 16. An operation panel 22 is placed above the front cover 16 for setting the operation conditions.

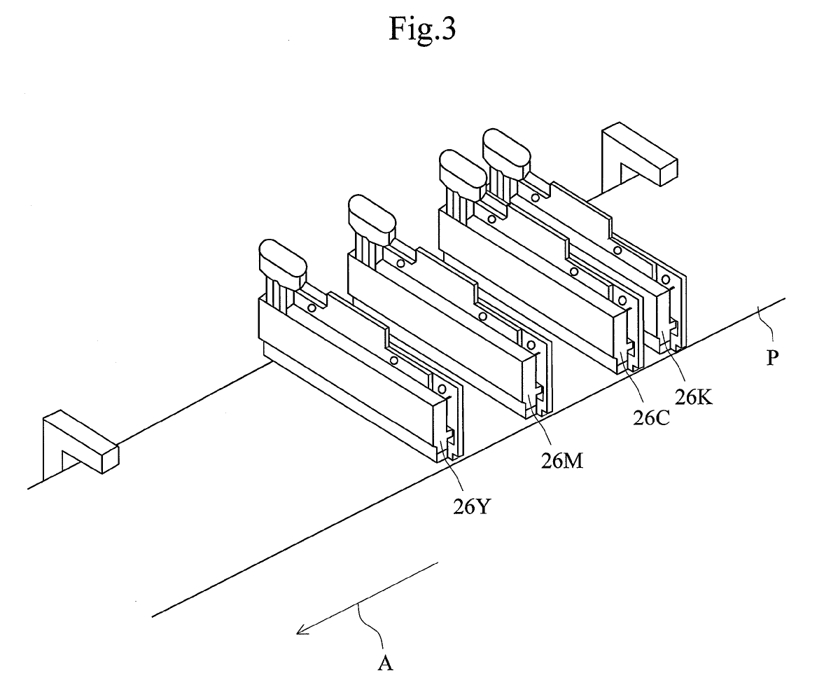

The internal structure of the ink-jet recording apparatus 10 illustrated in FIG. 1 is described with reference to FIG. 2 and FIG. 3.

FIG. 2 is a front view illustrating schematically the internal structure of the ink-jet recording apparatus illustrated in FIG. 1. FIG. 3 is a perspective view illustrating arrangement of the four recording heads.

To the ink-jet recording apparatus 10, a host computer 24 (personal computer) is connected which sends image information (printing data) to the ink-jet recording apparatus 10. This ink-jet recording apparatus 10 has four recording heads 26K, 26C, 26M, 26Y arranged in the direction (arrow-A direction) of the delivery of the recording sheet P (rolled paper sheet) . The four recording heads 26K, 26C, 26M, 26Y eject respectively an ink of colors of black, cyan, magenta, and yellow. These four recording heads 26K, 26C, 26M, 26Y are line heads, and extend in the direction perpendicular to the face of the drawing of FIG. 2 (perpendicular to arrow-A direction). The length of each of the four recording heads 26K, 26C, 26M, 26Y is slightly larger than the maximum breadth of printing on the recording medium (the length in the direction perpendicular to the face of the drawing) by the ink-jet recording apparatus 10. These four recording heads 26K, 26C, 26M, 26Y are positionally fixed during image formation.

The printer 10 contains a recovery unit 40 for stabilizing the ink ejection from the four recording heads 26K, 26C, 26M, 26Y. This recovery unit 40 recovers the initial ink ejection state of the recording heads 26K, 26C, 26M, 26Y. The recovery unit 40 has capping mechanisms 50 for removing, in the recovery operation, the ink from the faces 26Ks, 26Cs, 26Ms, 26Ys of the ink ejection outlets of the four recording heads 26K, 26C, 26M, 26Y. The capping mechanisms 50 are equipped for each of the recording heads 26K, 26C, 26M, 26Y. In FIG. 1, six capping mechanisms 50 are provide for six colors, two of which are extra units for supplement of the recording heads. The capping mechanism 50 contains a blade, an ink-removing member, a blade-supporting member, and a cap. The recovery unit 40 can serve also to remove a bubble in the ink by circulating the ink between the recording heads 26K, 26C, 26M, 26Y and sub-tanks (not shown in the drawing) by pressing and sucking the ink in the recording heads 26K, 26C, 26M, 26Y.

The rolled paper sheet P is fed from a roll unit 12 and is delivered in the arrow-A direction by a delivery mechanism 30 incorporated in the ink-jet recording apparatus 10. The delivery mechanism 30 contains a delivery belt 30a for delivering the rolled paper sheet P thereon, a delivery motor 30b for driving the delivery belt 30a, and a roller 30c for applying a tension to the delivery belt 30a.

In image formation on the rolled paper sheet P, on arrival of the record start position of the rolled paper sheet P at the position under the black recording head 26K, black ink is ejected selectively from the recording head 26K in accordance with the printing data (image information). Similarly, the color inks are ejected from the recording head 26C, the recording head 26M, and the recording head 26Y in the named order to form a color image on the rolled paper sheet P. The ink-jet recording apparatus 10 has, an addition to the above-mentioned parts and members, main tanks 28K, 28C, 28M, 28Y for storing the inks to be fed to the recording heads 26K, 26C, 26M, 26Y; and a tube pump (not shown in the drawing) for ink feeding and ink ejection recovery.

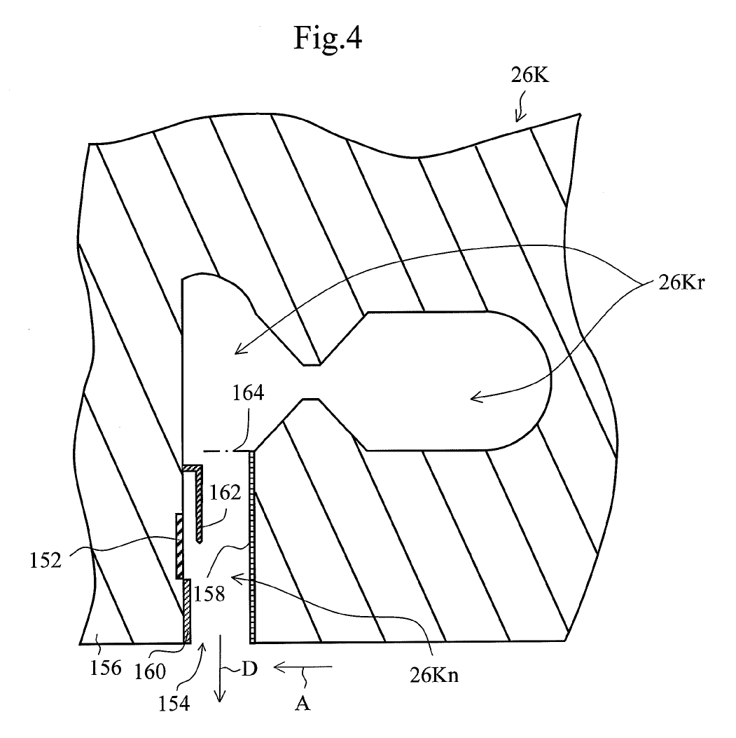

The structure of the nozzle Kn of the recording head 26K is described with reference to FIG. 4. The other nozzles of the recording heads 26Y, 26M, 16C has the same structure. FIG. 4 is a sectional view of a nozzle and the periphery thereof. FIG. 4 is a sectional view of a nozzle and periphery thereof. FIG. 4 illustrates only one nozzle 26Kn. However, the recording head 26K has many nozzles arranged in the direction perpendicular to the recording medium delivery direction.

The recording head 26K has many nozzles 26Kn for ink ejection arranged in the direction perpendicular to the face of the drawing of FIG. 4. The many nozzles 26Kn are connected to (communicated with) the common liquid chamber 26Kr storing the ink. This common liquid chamber 26Kr is connected to a sub-tank (not shown in the drawing) to feed the ink from the sub-tank to the common liquid chamber 26Kr.

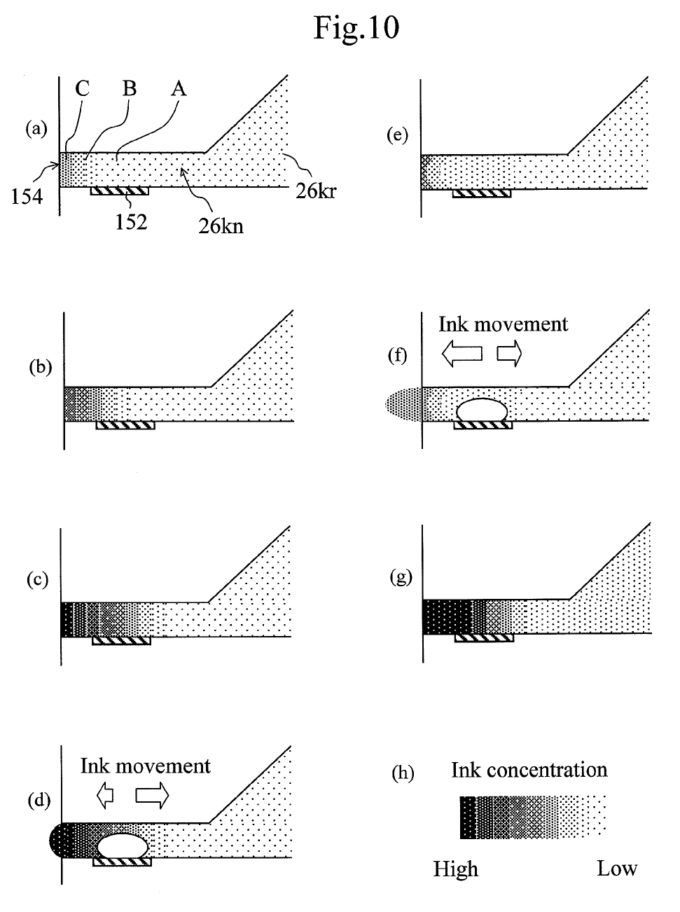

In the nozzle 26Kn, a heater 152 (an example of the heating element of the present invention) is equipped for causing the bubbling in the ink (for forming a bubble). On supplying an electric power to the heater 152 for heating (energizing), a bubble is generated in the ink in the nozzle 26Kn to push and eject the ink as a droplet through the outlet (ink ejection outlet 154) of the nozzle 26Kn. The ejection of the ink droplet is described later with reference to FIG. 10, and other drawings.

The heater 152 is formed on a silicon element substrate 156 by a conventional technique. A silicon top plate 158 and a nozzle-I 160 are formed on the silicon element substrate 156 for uniformizing the wetting property of the ink near the meniscus (not shown in the drawing). The silicon top plate 158 and the nozzle-I 160 are formed on the inside wall of the nozzle Kn. The nozzle-I 160 is formed on the inside wall near the ink outlet 154 of the nozzle 26K to narrow the ink ejection outlet 154.

The common ink chamber 26Kr is also formed in the silicon element substrate 156. Further, in the silicon element substrate 156, there are formed a valve 162 for directing the ink on bubbling by the heater 152 efficiently to the ink ejection direction (arrow-D direction), and a flow path wall 164 extending perpendicularly from the silicon top plate 158 inward. The nozzle-I 160 is provided to prevent chipping of the silicon top plate 158 in cutting in production of many nozzles 26Kn.

The heater 152 is formed by patterning of the resistance layer and the wiring. The heater 152 is energized by applying a voltage through this wiring to the resistance layer to generate heat in the heater 152. The generated heat causes bubbling of the ink on the surface of the heater 152 and ejects the ink through the ink ejection outlet 154. Additionally, a Di sensor (not shown in the drawing) is placed on the silicon element substrate 156 for detecting the temperature of the thermal energy accumulated in the silicon element substrate 156 and the heater 152. The driving conditions of the recording head 26K are determined based on the temperature detected by the Di sensor.

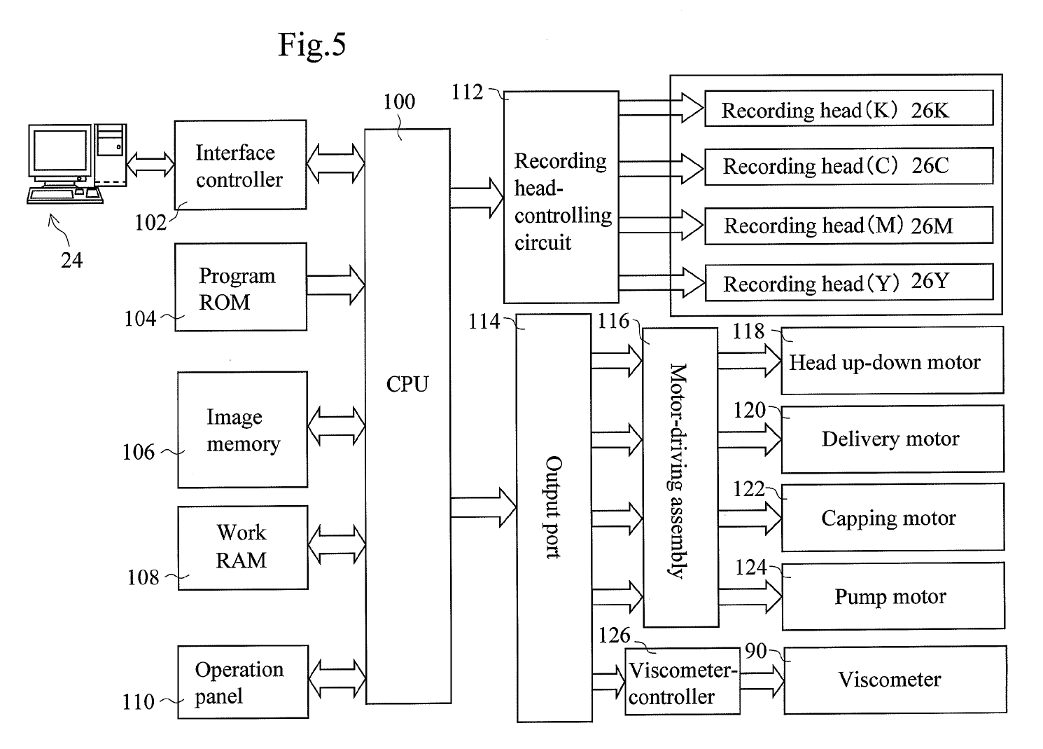

The electric system of the ink-jet recording apparatus 10 is described with reference to FIG. 5.

FIG. 5 is a block diagram showing the electric system of the ink-jet recording apparatus illustrated in FIG. 1.

The data or commands for recording are transmitted from the host PC 24 through an interface controller 102 to a CPU 100. The CPU 100 is a central processing unit for controlling the printer 10 as a whole such as reception of recording data, operation of recording, and handling of the rolled paper sheet P. The CPU 100, after analyzing received commands, develops the image data of the respective color as a bit map in the image memory 106 and draws an image. Prior to the recording, a capping motor 122 and a head-moving motor 118 are driven through an output port 114 and a motor-driving assembly 116 to move the recording head 26K, 26C, 26M, 26Y apart from the capping mechanisms 50 (FIG. 1) to the recording position (image formation position).

Then a roll motor (not shown in the drawing) for sending out the rolled paper sheet P and a delivery motor 120 for delivering the rolled paper sheet P at a low delivery rate are driven to deliver the rolled paper sheet P through the output port 114 and the motor-driving assembly 116 to the recording position. The position of the leading edge of the rolled paper sheet is detected by a leading edge-detecting sensor (not shown in the drawing) to decide the timing of ejection of the ink onto the rolled paper sheet P being delivered at a constant rate. Thereafter, in synchronization with the delivery of the rolled paper sheet P, the CPU 100 reads out corresponding color recording data from the image memory 106 successively, and transmits the data through a printing head-controlling circuit 112 to the respective recording heads 26K, 26C, 26M, 26Y. The recording head-controlling circuit 112 controls the timing of application of the electric pulses to the heater 152 (FIG. 4).

The CPU 100 is operated in accordance with the processing program memorized in a program ROM 104. The program ROM 104 memorizes the processing-program and tables corresponding to the control flow. A work RAM 108 is used as the operation memory. In the operations of cleaning and recovery of the respective printing heads 26K, 26C, 26M, 26Y, the CPU 100 controls ink pressurization and ink sucking by driving a pump motor 124 through the output port 114 and a motor-driving assembly 116, and detects the viscosity through the output port 114.

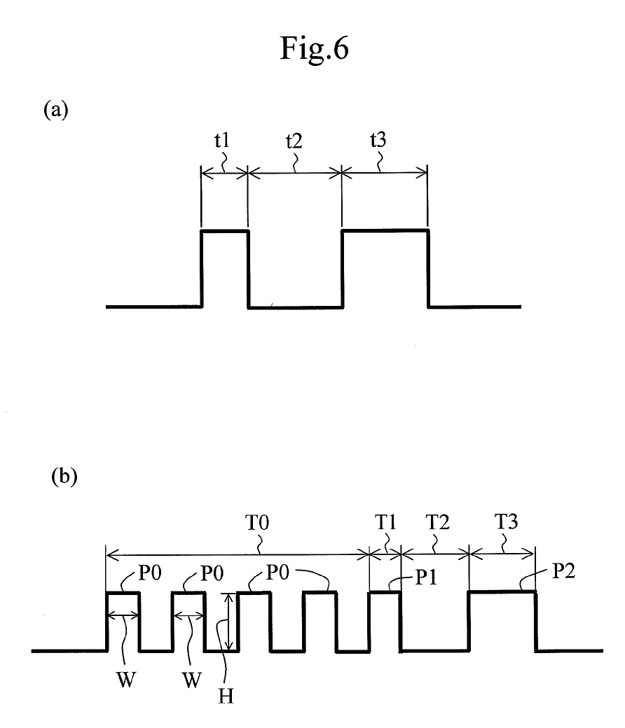

The ink is ejected through the nozzle 26Kn of the recording head 26K by bubble formation near the heater 152 under control of the heat generation of the heater 152 (FIG. 4) by the recording head-controlling circuit 112. The technique of application of a voltage pulse to the heater 152 is described with reference to FIG. 6.

FIG. 6A is a graph showing voltage pulses in a conventional method. FIG. 6B is a graph of an example of the voltage pulses in the present invention.

In the conventional technique shown in FIG. 6A, to eject an ink droplet through the nozzle 26Kn (FIG. 4) by energizing (imparting a thermal energy to) the heater 152 (FIG. 4), three steps are involved: pre-pulse time t1 (preliminary heating time), off time t2 (stop-diffusion time), and main heat-pulse time t3 (heat-bubbling time). The pre-pulse time t1, the off time t2, and the main heat-pulse time t3 are adjusted depending on the type of the ink-jet recording apparatus 10 and the ink used, usually within the range from about 0.5 to 3 microseconds. Before the pre-pulse time t1, the heaters 152 of all the nozzles of all the recoding heads are kept energized to keep the ink in the nozzles at a constant temperature.

In the pre-pulse time t1, an electric current is allowed to pass through the heater 152 (FIG. 4) (the heater 152 is energized) for the time t1. The current imparts a thermal energy to the ink in the nozzle 26Kn (FIG. 4) to lower the viscosity of the ink to raise the ink ejection efficiency. After the pre-pulse time t1, the heater 152 is turned off (the heater 152 is not energized) for the off time t2. After the lapse of the off-time t2, the heater 152 is turned on (the heater 152 is energized) for the main heat-pulse time t3. In the main heat-pulse time t3, film boiling is caused on the surface of the heater 152 to eject the ink.

The off time t2 is provided between the pre-pulse time t1 and the main heat-pulse time t3 in order to diffuse the heat generated in the pre-pulse time t1 into the ink in the nozzle to raise the ink ejection efficiency. Before the pre-pulse time t1 also, the ink in all the nozzles in all the recording heads is heated uniformly to a temperature so as not to cause ink ejection. This heating promotes evaporation of water from the ink in the nozzle to cause increase of the viscosity of the ink.

On the other hand, in the present invention, the simultaneous uniform heating of all the nozzles of all the recording heads is not conducted. In the present invention, as shown in FIG. 6B, the ink in the nozzle is heated within a temperature range not to cause ink ejection (voltage pulses P0 are applied plural times to the heater 152) corresponding to the exposure time (tw mentioned later) of the respective nozzles, and subsequently voltage pulses P1, P2 are applied to the heater 152 to cause bubbling and ejection of the ink. The number of times of application of the voltage pulse P0 (four times in FIG. 6B), the width W and intensity H of the pulse P0, the time length T0 of application of P0, and the time lengths of T1, T3 of application of the voltage pulse P1, P2 depend on the type of the ink-jet recording apparatus 10 and the kind of the ink, so that they are determined preliminarily by experiment. The term “exposure time” herein signifies the time interval between one ejection of the ink from a nozzle and the subsequent ejection of the ink. This exposure time is different for each of the nozzles. The above wording “subsequent ejection” may be replaced to “start of heating for the subsequent ejection”, since the time of this heating is extremely short. Incidentally, the description made regarding the nozzle 26Kn of the recording head 26K can be applied also to other recording heads 26Y, 26M, 26C.

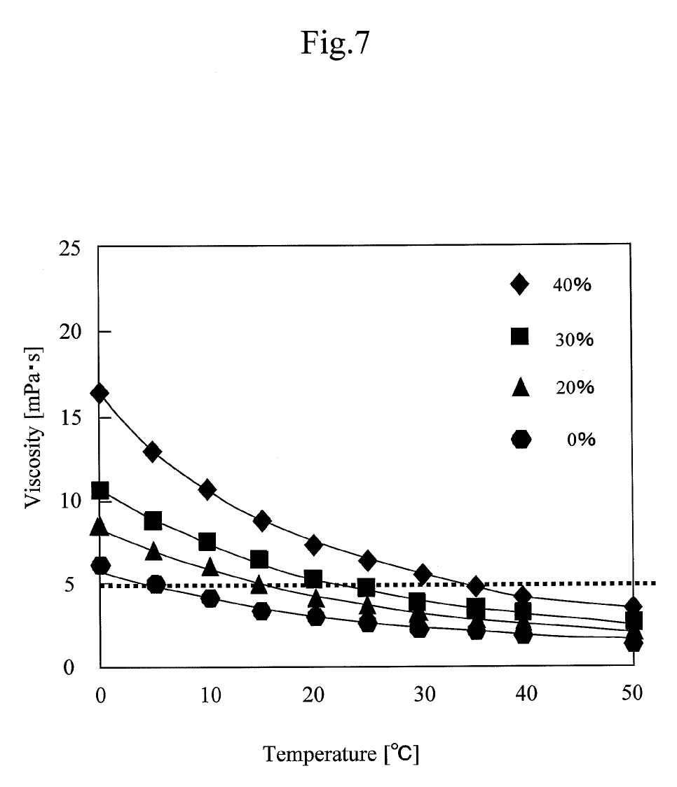

The increase of the viscosity of the ink in the nozzle during the exposure of the nozzle of the recording head is described with reference to FIG. 7. FIG. 7 is a graph showing dependence of the viscosity of the ink on the temperature, the abscissa indicating the temperature (° C.), and the ordinate indicating the viscosity (mPa·s) of the ink. In FIG. 7, the solid marks of rhomboid, square, triangle, and octagon denote respectively a ratio of evaporation of water from the ink: the rhomboid, 40%; the square, 30%; the triangle, 20%; the octagon, 0%.

The longer time of the exposure of the nozzle in the open air causes a larger increase of the viscosity of the ink in the nozzle by evaporation of water from the ink, whereas the higher temperature lowers the ink viscosity. For example, an ink from which 40% of the water has evaporated has a viscosity of about 16 mPa·s at 0° C., but has a lower viscosity of about 4 mPa·s at 50° C.: an ink from which the water has not evaporated (water evaporation rate 0%) has a viscosity of about 6 mPa·s at 0° C., but has a lower viscosity of about 2 mPa·s at 50 ° C. Thus the viscosity of the ink depends on the water evaporation ratio of the ink and the temperature of the ink. In combination of the recording head and the ink in this Example, the ejection failure occurs more frequently at the ink viscosity of higher than 5 mPa·s.

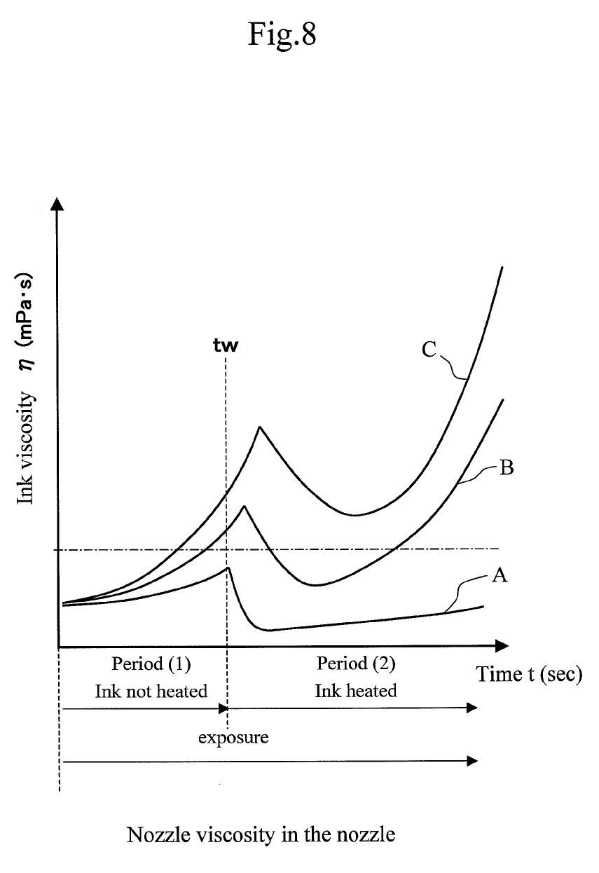

Next, the ink viscosity dependent on the location (region) of the ink in the nozzle is described with reference to FIG. 8. FIG. 8 is a graph showing change of the ink viscosity depending on the position in the nozzle, the abscissa indicating the time (seconds), and the ordinate indicating the viscosity (mPa·s) of the ink. The curve A denotes the ink viscosity near the heater 152 (FIG. 4), the curve B denotes the ink viscosity at the midpoint between the heater 152 and the ink ejection outlet 154 (FIG. 4), and the curve C denotes the ink viscosity near the ink ejection outlet 154 (FIG. 4).

After exposure of the nozzle 26Kn (FIG. 4) for a short time without energizing the heater 152, the heating of the ink is started after a time of tw second from the previous ink ejection by energizing the heater 152. The water evaporates more at the portion nearer to the ink ejection outlet 154 to cause increase of the viscosity, whereas, at the portion apart from the ink ejection outlet 154 and nearer to the liquid chamber 26Kr (FIG. 4), the water is less liable to evaporate and the viscosity is less liable to increase. In consideration of ejection of the ink through the nozzle 26Kn, the ink viscosity at the front portion of the nozzle 26Kn represented by the curve B is taken as the mean viscosity affecting the ejection.

As shown in FIG. 8, the viscosity of the ink in the nozzle 26Kn will increase with the exposure of the nozzle 26Kn. After the time of tw second, the heater 152 is energized, whereby the viscosity is lowered by the temperature rise by heat generation of the heater 152. However, the rise of the ink temperature promotes evaporation of water to cause increase of the viscosity with the lapse of the time.

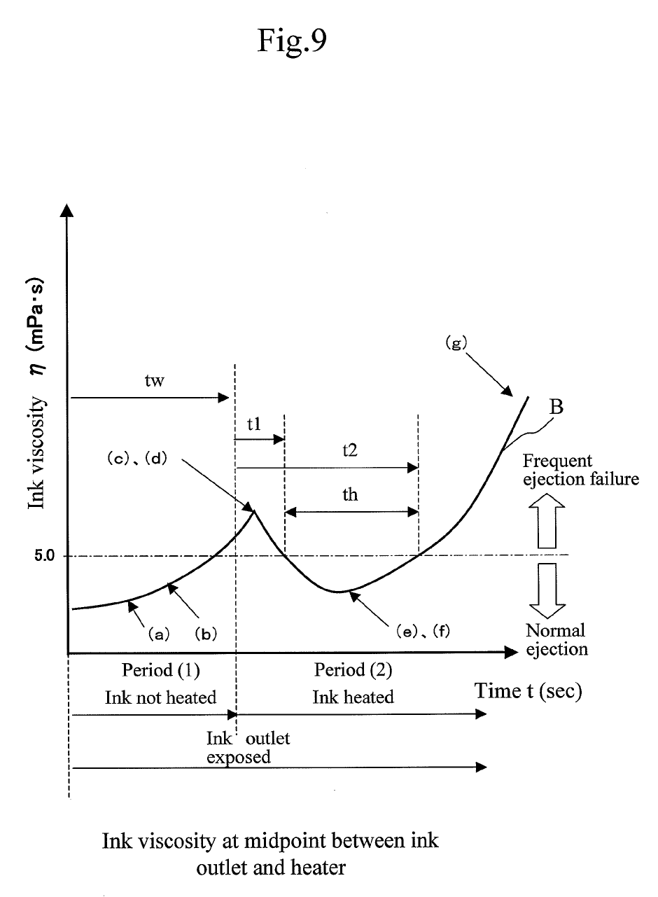

The progression of the increase of the ink viscosity is described with reference to FIG. 9 and FIG. 10. FIG. 9 is a graph showing the ink viscosity at the midpoint between the heating element and the ink ejection outlet, the abscissa indicating the time (seconds), and the ordinate indicating the viscosity (mPa·s) of the ink. FIG. 10 is schematic drawings illustrating change of the ink viscosity.

During exposure of the nozzle 26Kn (FIG. 4) without heating, the ink in the nozzle 26Kn becomes gradually more viscous by drying as shown in the period-1 in FIG. 9. The viscosity of the ink increases gradually from the tip portion of the nozzle 26Kn as illustrated in FIGS. 10A-10C. As illustrated in FIG. 10C, in the portion near the liquid chamber 26Kr, the ink diffuses less to cause less the viscosity increase.

When the viscosity of the ink has increased to a state as illustrated in FIG. 10C, the viscosity exceeds the range for normal ejection, tending to cause ink ejection failure (a phenomenon of non-ejection). In the state shown in FIG. 10C, even if the voltage pulse is applied to the heater 152 to eject the ink, bubbling occurs as illustrated in FIG. 10D, and the ink is driven mainly toward the liquid chamber 26Kr owing to the viscosity difference in the ink and the ink is ejected little from the nozzle 26Kn.

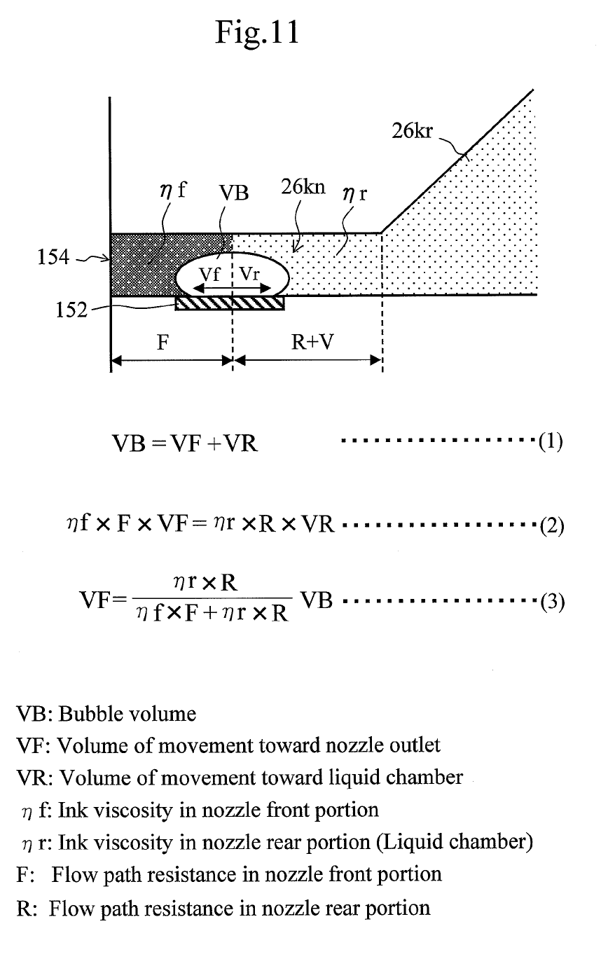

The reason is describe why the amount of the ejection decreases owing to the viscosity difference in the ink, with reference to FIG. 11. FIG. 11 illustrates schematically the difference in the ink viscosity between the front portion and the rear portion in the nozzle, and equations for representing the movement of the ink forward and backward by bubbling in the nozzle.

In FIG. 11, Equation 1 shows that the volume of the bubble is equal to the sum of the volumes of the forward and backward movement of the ink. Equation 2 indicates the balance of the forces causing the forward and backward movement of the ink. Equation 3 is derived from Equation 1 and Equation 2. According to these Equations, the ink tends to flow in the direction of the lower flow resistance and lower ink viscosity in the nozzle. Thus, when the ink becomes excessively viscous in the front portion in the nozzle, the ink is driven hardly frontward by the bubbling.

FIG. 10E illustrates the state in which a voltage pulse is applied to the heater 152 (the heater 152 is energized) to a temperature so as not to cause ink ejection to lower the ink viscosity to enable ink ejection in the period-2 in FIG. 9. The heat generated in the heater 152 raises the temperature of the ink in the nozzle to lower the viscosity of the ink around the heater 152. Further, heat is transferred toward the valve 162 to warm the ink to lower the viscosity around the valve.

In the state of FIG. 10E, the ink viscosity has been lowered to enable normal ink ejection. Thereby the ink can be ejected normally as illustrated in FIG. 10F. FIG. 10G illustrates a state in which the heating to a temperature so as not to cause ink ejection is conducted for a long time to cause excessive evaporation of the water from the ink and excessive viscosity increase, interrupting the ink ejection owing to the high viscosity.

As described above, when the ink is kept heated below the ejection temperature before reception of printing data, the viscosity of the ink increases. Therefore in order not to cause the undesired viscosity increase, the ink is not heated during a standby time; the ink in the respective nozzles is heated below the ink ejection temperature before the ejection in accordance with the exposure time of the nozzle not employed for ejection; and thereafter the ink is allowed to bubble for the ejection. This is desirable for preventing the ink viscosity increase and improving the ink ejection performance and ink ejection reliability. In practice, the heater 152 is controlled in such a manner that until the recording head-controlling circuit 112 (FIG. 5) or the CPU 100 (FIG. 5) receives printing data, the heater 152 is not energized; when the recording head-controlling circuit 112 or the CPU 100 has received the printing data, the heater in the respective nozzles are selectively energized to eject the ink selectively. In other words, the ink in the nozzle is not heated (the electric pulse is not applied to the heater 152) until the instant immediately before the printing to prevent the viscosity increase. Then the ejection interval (exposure time) of each of the nozzles is estimated from the printing data, and a voltage pulse P0 is applied to the heater 152 not to cause ejection of the ink in accordance with the exposure time of the nozzle as shown in FIG. 6B. Thereby, the ink ejection performance and the ink ejection reliability can be improved without causing the increase of the ink viscosity.

The present invention is compared with the conventional technique with reference to FIG. 6.

In the conventional technique as shown in FIG. 6A, for example, the temperature of the ink in the nozzle is controlled to be at 30° C. during the nozzle standby time and the printing time and the pulse width (t1) is controlled at 0.8 μsec and the main heat pulse width (t3) is controlled at about 2.0 μsec. In contrast in an example of the present invention, the temperature control at 30° C. is not conducted during the standby time and the printing time, but instead as shown in FIG. 6B, the pulse width of preheating pulse P0 before the main heating pulse P2 and the preheating pulse P1 is adjusted to 1.6 μsec, the frequency of the preheating pulse P0 is adjusted to be 2400 Hz (the same as the frequency for the ink ejection), and the number of the pulses (times of P0) is made variable. Thereby the ink ejection performance and the ink ejection reliability are improved without causing the ink viscosity increase in comparison with the conventional technique.

For example, in an environment of a temperature of 23° C. and a humidity of 30%, the number of times of the preheating pulse P0 (total number) is 2400 pulses. In the comparative example as mentioned above, the temperature of the ink in the nozzle is controlled to be at 30° C. both during the standby time and during the printing time, the pulse width (t1) of the preheating pulse is adjusted to 0.8 μsec, and the pulse width (t3) is adjusted to be about 2.0 μsec. In the comparative example, under such conditions, ejection failure occurs about 50 seconds after the start of exposure owing to the viscosity increase, whereas in an example of the present invention in which the number of times (total number) of the preheating pulse P0 is 2400, the ejection failure does not occur about 100 seconds after the start of the exposure. Thereby the effectiveness of the present invention is confirmed.

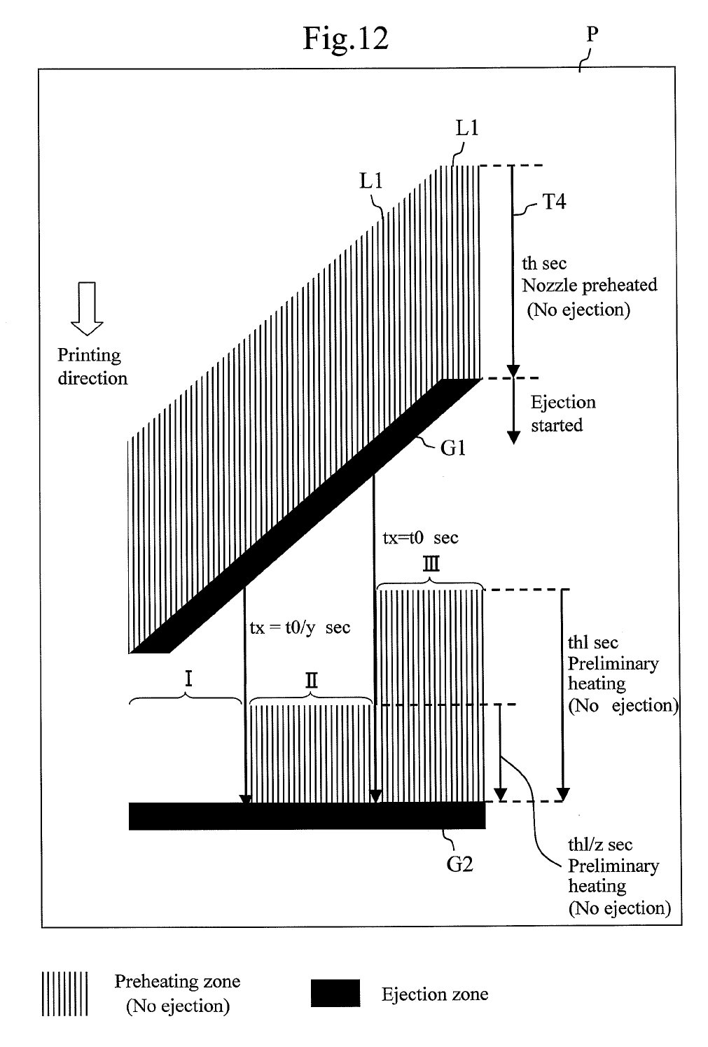

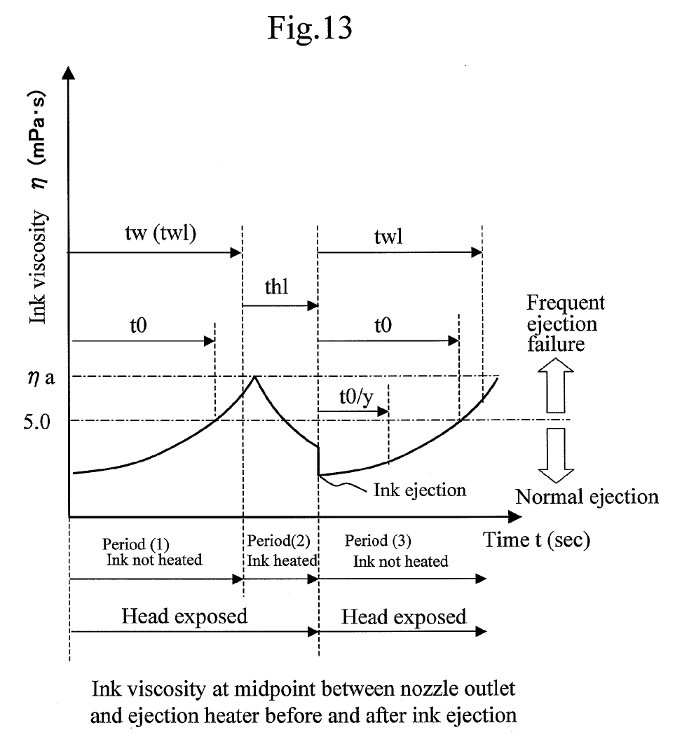

In the above example, the present invention is conducted with the ink-jet recording apparatus 10. For conducting the present invention with another ink-jet recording apparatus, parameters should be used to meet the ink-jet recording apparatus employed. An example in which the nozzle exposure time and the time period of heating of the ink are taken as variables is described with reference to FIG. 12 and FIG. 13. FIG. 12 illustrates schematically an example of the present invention. In FIG. 12, the black solid stripe shows an image formed on the recording medium. FIG. 13 is a graph showing an example of change of the ink viscosity with time in the present invention, the abscissa denoting the time (second) and the ordinate denoting the ink viscosity (mPa·s). The symbols in FIG. 12 and FIG. 13 denote the followings:
tw: the time length of exposure of the nozzle without heating of the ink between two successive ejections (exposure time);
tw1: the longest time of the exposure of the head without ink heating;
th: the time of heating without ink ejection during the time between the two successive ink ejections;
th1: the longest time of the heating without the ink ejection;
t0: the time for the increase of the viscosity to reach 5.0 mPa·s after the start of the exposure of the ink ejection outlet (immediately after the previous ink and ejection);
ηa: the upper limit of the viscosity below which the viscosity can be lowered for normal printing;
tx: the time interval between the two successive ink ejections, i.e., tx=tw+th.

In printing the image of “/” (a slant solid stripe) G1 as illustrated in FIG. 12, only the heaters for ejecting the ink for forming the image G1 of the slant solid stripe G1 are energized for heating below the ink ejection temperature. The energizing of the heaters (application of the voltage pulses) is started th-second before the ink ejection. The timings of start of energizing of the heater of the respective ink ejection nozzles are represented by the fine lines L1 in FIG. 12. The heaters of the nozzles not employed for the ink ejection are not energized, so that the ink viscosity increase is retarded in comparison with the case of uniform heating of all the nozzles. The preheating zone T4 (corresponding to time th) in FIG. 12 denotes the heaters energized below the ink ejection temperature and the time (period) thereof.

In FIG. 12, tx-second after printing of the image “/” (slant solid stripe) G1, an image “-” (horizontal solid stripe) G2 is printed. In this case, the same nozzles are employed as those in printing of the image “/” (slant solid stripe) G1 for the ink ejection. However, the exposure time is different among the nozzles. Therefore the exposure time is classified into groups by a time range, and the time th is varied for each of the groups. For the nozzles of group I, which have been exposed only for a very short time of tw, the time th is zero. For the nozzles of group II, which has been exposed for a short time of tw, the time th is adjusted to be th1/z. For the nozzles of group III, which have been exposed for a relatively long time of tw, the time th is adjusted to th1.

As shown in FIG. 13, without heating of the ink, the viscosity of the ink increases with the time until the ejection of the ink. The ejection of the ink allows a flesh ink to flow from the liquid chamber into the nozzle, and the ink viscosity restores to the initial level. Thereafter, without the nozzle heating and with the ink ejection outlet exposed (uncapped), the viscosity of the ink in the nozzle increases gradually owing to the evaporation as described above.

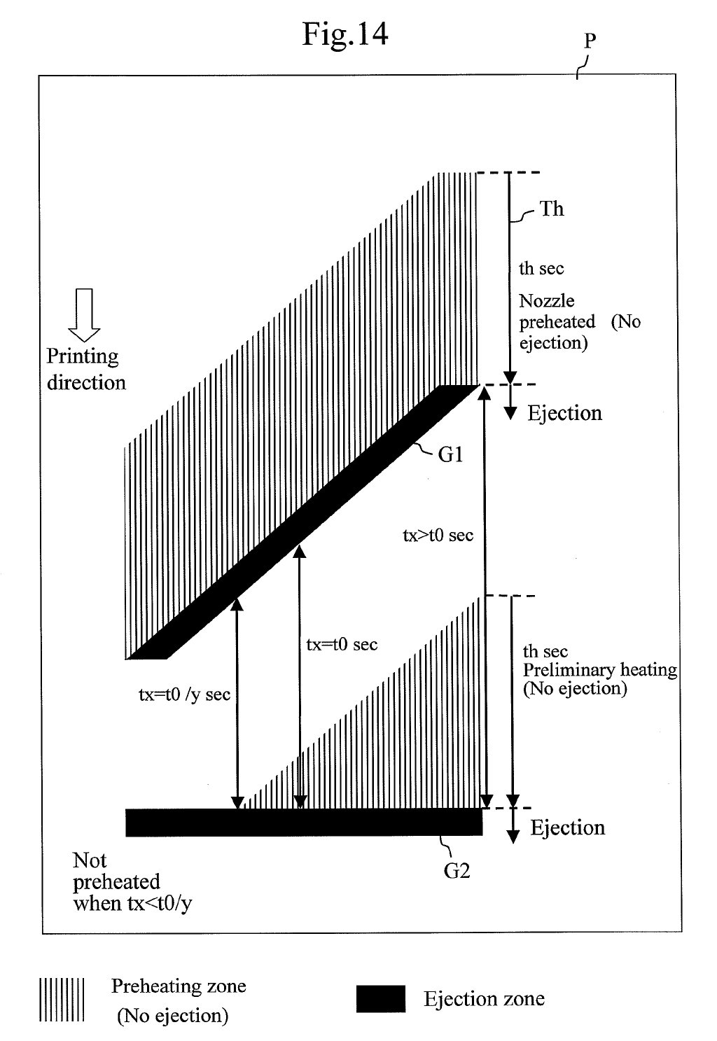

Immediately after tx second from the ejection of the ink, in order to eject the ink subsequently, the time th should be decided suitably to correspond to the time tx depending on the conditions. The decision of tx is described below with reference to FIG. 14 as an example. FIG. 14 illustrates schematically another example of the present invention. In FIG. 14, the black solid stripe shows an image formed on the recording medium, and the same symbols as in FIG. 12 are used for denoting the corresponding constitution elements.

In the case where the respective heaters of the nozzles can be controlled independently, preliminary heating of the ink is started after t0/y second (y is a variable) from the previous ink ejection when the viscosity of the ink comes close to 5.0 mPa·s tending to cause ejection failure. On the other hand, when the subsequent ejection is conducted within t0/y second after the previous ejection, the preliminary heating is not conducted since the viscosity of the ink low enough for the ejection.

In the case where the ink-jet recording apparatus 10 is limited in the performance thereof, several patterns of the preliminary heating time (second) (T1 in FIG. 6B, total number of the preheating pulses P1) are decided, and a suitable preheating time (T1 in FIG. 6) is selected from the patterns corresponding to the time interval (exposure time) between successive ejection. Otherwise, the plural nozzles are classified into several groups as shown in FIG. 12, and the heaters are controlled for the group units. For example, in printing in a density of 600 DPI, 2400 nozzles are respectively controlled for printing in the width of 4 inches. By controlling adjacent eight nozzles as one block (one group), 300 nozzles have only to be controlled, which decreases the load to the CPU. With eight nozzles in one block, one nozzle is controlled and other seven nozzles are treated together. Strictly, in the printing of the solid stripe G1, the timings of the start of the heating are controlled in steps, but the purpose can be achieved thereby.

Next, a method is described for deciding the times depending on the lengths of tx, t0/y, tx, and tw1+th1

When tx<t0/y, the ink viscosity is within the range appropriate for the ink ejection, and preheating of the ink is not necessary. Therefore, tw=tx, and th=0. The above variable y is substituted by a suitable value.

When t0/y<tx<t0, the ink viscosity is close to 5.0 mPa·s, which can cause ink ejection failure. To prevent the ejection failure, the ink is heated to lower the viscosity. Therefore, tw=tx−th1/z, and th=th1/z. The variables y and z are substituted by suitable values.

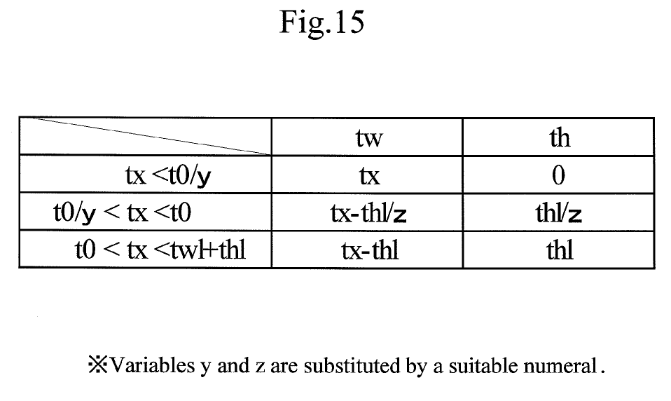

When t0<tx<(tw1+th1), the viscosity is in the range to cause frequently the ejection failure, and the ink is heated to lower sufficiently the viscosity. Therefore, tw=Tx−th1, and th=th1. FIG. 15 shows the exposure time tw and the time th as functions of the time tx.

With the time th selected according to the time tx, the image “-” (horizontal stripe) G2 can be printed subsequently after the printing of the image “/” (slant stripe) G1 without the rise of the viscosity with satisfactory ejection performance and ejection reliability.

To practice the present invention, the cases are classified by the length of the time tx as described above. In the above example, the time tx is divided into three, and the preheating time is classified into three levels. The levels may be selected suitably. The ink viscosity, tw1, th1, and t0 are greatly affected by the temperature and humidity of the environment. Therefore, the ink viscosity, tw1, th1, and t0 should be selected in correspondence with the temperature and humidity of the environment.

According to the present invention as described above, only the nozzles selected for printing (nozzles for ink ejection) are heated in a short time, whereby increase of the ink viscosity can be retarded and the ejection performance and ejection reliability can be improved. Further according to the present invention, the ink is not heated in the nozzles during the standby period in which the ink is not ejected, whereby the increase of the ink viscosity can be retarded. Further, the ink is heated depending on the exposure time, whereby the ink exposed for a short time is heated correspondingly for a short time, whereby the increase of the ink viscosity can be further retarded. Furthermore, the ink is heated to an extent not to cause ink ejection, and then the ink is ejected by bubbling of the ink, whereby the ink ejection performance and ink ejection reliability can be improved.

1. An inkjet type image-forming apparatus for forming an image on a recording medium by ejection of an ink from a plurality of nozzles selectively, comprising:
a calculation unit for calculating a time of standby of the nozzle to be employed for image formation,
a judgment unit for judging relation of the viscosity of the ink with the time of non-ejection, and
a selection unit for selecting the ink of the nozzle to be heated based on the judgment by the judgment unit; and
ejecting the ink from the nozzles after completion of the control by the selection unit to form an image.

2. The ink-jet type image-forming apparatus according to claim 1, wherein the ink is heated intermittently.

3. An ink-jet type image-forming apparatus having a recording head having a plurality of nozzles for ejecting an ink by heating by a heater element provided in each of the nozzles, and a controller for controlling the heater elements based on received printing data; and forming an image by ejection of the ink from a nozzle selected from the plurality of the nozzles onto a recording medium,
wherein the controller does not energize the heater elements before receiving the printing data, and energizes selectively the heater elements on receiving the printing data to heat the ink to a temperature so as not to cause ejection of the ink in accordance with exposure time between completion of the previous ejection based on the previously received printing data and start of the subsequent ink ejection based on the subsequently received printing data, and further energizes the selected heater elements to eject the ink from the plural nozzles in accordance with the subsequently received printing data.

4. The ink-jet type image-forming apparatus according to claim 3, wherein the ink is heated intermittently.

5. The ink-jet type image-forming apparatus according to claim 3, wherein the controller applies a voltage pulse to the heater element in controlling the heater element to a temperature so as not to cause ejection of the ink.

6. The ink-jet type image-forming apparatus according to claim 5, wherein the controller changes the number of the voltage pulses applied to the heater element in accordance with the respective exposure time of the nozzles.

7. The ink-jet type image-forming apparatus according to claim 5, wherein the controller changes the width of the pulse applied to the heater element in accordance with the respective exposure time of the nozzles.

8. The ink-jet type image-forming apparatus according to claim 5, wherein the controller changes the intensity of the pulse applied to the heater element in accordance with the respective exposure time of the nozzles.
